(19) United States
(12) Patent Application Publication
(10) Pub. No.: US 2022/0050554 A1
(43) Pub. Date: Feb. 17, 2022

(54) TOUCH PANEL AND TOUCH DISPLAY DEVICE

(71) Applicants: Beijing BOE Display Technology Co., Ltd., Beijing (CN); BOE Technology Group Co., Ltd., Beijing (CN)

(72) Inventors: Yilin FENG, Beijing (CN); Wei SUN, Beijing (CN); Wenchao HAN, Beijing (CN); Lianghao ZHANG, Beijing (CN); Xiaofeng YIN, Beijing (CN); Xinle WANG, Beijing (CN)

(21) Appl. No.: 17/254,635

(22) PCT Filed: Mar. 24, 2020
(86) PCT No.: PCT/CN2020/080985

§ 371 Date: Dec. 21, 2020

(51) Int. Cl. G06F 3/044

(52) U.S. Cl. CPC G06F 3/0446

(57) ABSTRACT

The present disclosure provides a touch panel and a touch display device The touch panel includes: multiple touch units arranged in an array, each touch unit including a first touch electrode and a second touch electrode extending along a first direction and arranged along a second direction, the second touch electrode including M sub-second electrode blocks arranged in sequence along the first direction, and M≥2; first leads electrically connected with first touch electrodes in a one-to-one correspondence manner; and second leads, each of which being electrically connected with nth sub-second electrode blocks in respective second touch electrodes in touch units arranged along the first direction, and 1≤n≤M.

### CROSS REFERENCE TO RELATED DOCUMENTS

The present application is a national phase entry under 35 U.S.C. § 371 of International Application No. PCT/CN2020/080985, filed on Mar. 24, 2020.

### FIELD

The present disclosure relates to the field of display technology, in particular to a touch panel and a touch display device.

### BACKGROUND

Along with the development of intelligent technology, the display screens (touch screens) with a touch function have been more and more widely used. The existing mainstream touch screens are mainly divided into touch screens with an on cell solution and touch screens with an in cell solution. For example, as to the on cell solution, a touch layer is embedded between a color filter substrate and a polarizer; and as to the in cell solution, a touch layer is embedded into the pixel units, and a common electrode on the TFT array substrate is taken as a touch sensor. A touch screen includes multiple touch electrodes, and the touch electrodes are connected with a touch driver chip through touch leads.

### SUMMARY

Embodiments of the present disclosure provide a touch panel, including:

a plurality of touch units arranged in an array; wherein each of the touch units includes a first touch electrode and a second touch electrode; the first touch electrode and the second touch electrode each is extending along a first direction and are arranged along a second direction; the second touch electrode includes a number M of sub-second electrode blocks arranged in sequence along the first direction; and M≥2;

first leads electrically connected with first touch electrodes in the respective touch units in a one-to-one correspondence manner; and

second leads, wherein each of the second leads is electrically connected with n^{th} sub-second electrode blocks in respective second touch electrodes in touch units arranged along the first direction, and 1≤n≤M.

In a possible embodiment, the first touch electrode is comb-shaped, and is provided with a first master which extends along the first direction, and a plurality of first branches which are connected with the first master and extend towards the second touch electrode along a direction vertical to the first direction.

Each of the number M of sub-second electrode block is comb-shaped, and is provided with a second master which extends along the first direction, and a plurality of second branches which are connected with the second master and extend towards the first touch electrode along the direction vertical to the first direction. The first branches and the second branches are distributed alternately.

In a possible embodiment, an extending length of the second master in the first direction is 1/M of an extending length of the first master in a same touch unit in the first direction.

In a possible embodiment, a width of the first master in the direction vertical to the first direction is larger than a width of each of the first branches in the first direction. A width of the second master in the direction vertical to the first direction is larger than a width of each of the second branches in the first direction.

In a possible embodiment, an extending length of each of the first branches is equal to an extending length of each of the second branches.

In a possible embodiment, each of the touch units is rectangular, the first touch electrode is block-shaped, each of the number M of sub-second electrode blocks is block-shaped, and a length of the each sub-second electrode block in the first direction is less than a length of the first touch electrode in the first direction.

In a possible embodiment, a width of the first touch electrode along a direction vertical to the first direction is equal to a width of the each sub-second electrode block along the direction vertical to the first direction.

In a possible embodiment, a shape of the each sub-second electrode block in a same touch unit is square.

In a possible embodiment, areas of the respective sub-second electrode blocks in the same touch unit are the same.

In a possible embodiment, a first lead connected with the first touch electrode is arranged on a side, far away from the second touch electrode, in a same touch unit.

In a possible embodiment, the second leads includes: a first type of touch leads each arranged on a side, far away from the first touch electrode, of the second touch electrode, and a second type of touch leads each of which is bended to form multiple segments for evading from the sub-second electrode block.

Each of the first type of touch leads is electrically connected with first sub-second electrode blocks in respective second touch electrodes in touch units arranged along the first direction, each segment in each of the second type of touch leads is electrically connected with n^{th} sub-second electrode blocks in two adjacent second touch electrodes in touch units arranged along the first direction; and 1<n≤M.

In a possible embodiment, the second leads further includes: a third type of touch leads each arranged on a side, facing towards the first touch electrode, of the second touch electrode.

Each of the third type of touch leads is electrically connected with last sub-second electrode blocks in respective second touch electrodes in touch units arranged along the first direction.

In a possible embodiment, the first touch electrode and the second touch electrode are arranged in the same layer.

In a possible embodiment, the first leads and the second leads are arranged in the same layer as the first touch electrode.

Embodiments of the present disclosure further provide a touch display device, including the touch panel provided in embodiments of the present disclosure.

In a possible embodiment, the touch display device further includes a display panel, the display panel is provided with multiple pixel units, and each of the pixel units includes a light transmitting area.

The first touch electrode, and/or the sub-second electrode block, and/or the first lead, and/or the second lead have/has a hollow part, and an orthographic projection of the hollow part on the display panel is overlapped with the light transmitting area of the pixel unit.

### BRIEF DESCRIPTION OF THE DRAWINGS

FIG. 1 is schematic diagram of pattern distribution of self capacitance touch in the related art;

FIG. 2 is a structural schematic diagram of a touch panel provided in an embodiment of the present disclosure;

FIG. 3 is a schematic diagram of an amplified structure of a touch unit in FIG. 2;

FIG. 4 is a structural schematic diagram of another touch panel provided in an embodiment of the present disclosure;

FIG. 5 is a schematic diagram of an amplified structure of a touch unit in FIG. 4;

FIG. 6 is a structural schematic diagram of a touch panel having a third type of touch leads provided in an embodiment of the present disclosure;

FIG. 7 is a structural schematic diagram of another touch panel having a third type of touch leads provided in an embodiment of the present disclosure;

FIG. 8 is a structural schematic diagram of first touch electrodes having hollow parts provided in an embodiment of the present disclosure.

### DETAILED DESCRIPTION OF THE EMBODIMENTS

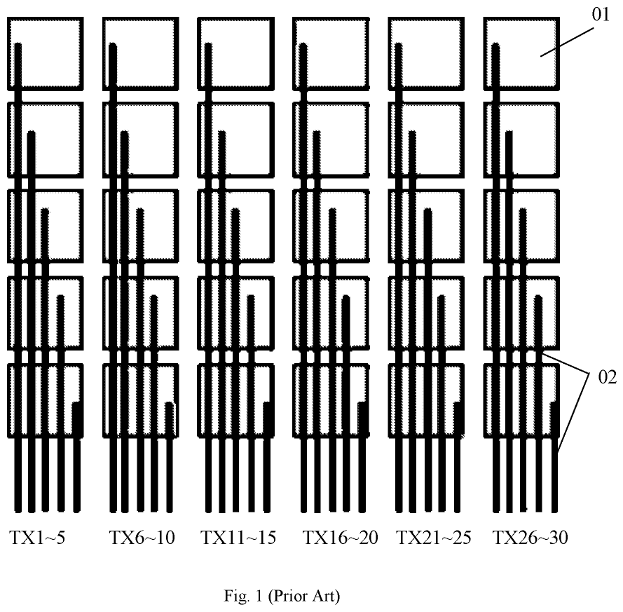

The self capacitance touch pattern of the existing touch panel is as shown in FIG. 1. The touch panel includes multiple touch electrode blocks 01. Each touch electrode block 01 is electrically connected with one touch lead 02 in a one-to-one correspondence manner. Each rectangular touch electrode block 01 (touch block) is a touch channel, thereby leading to the problem that the lower frame size and the touch chip size (touch IC size) are seriously influenced due to too many touch channels. While for the traditional mutual capacitance touch solution, such problems as unfavorable ghost point of multi-finger touch, distribution of the touch electrodes (sensors) and the leads in different layers, and an increase of manufacture procedures exist.

In summary, in the related art, mutual capacitance touch has such problems as unfavorable ghost point of multi-finger touch, requirement of multiple film layers, and complex manufacture procedures, and self capacitance touch has the problem that the lower frame size and touch chip size are influenced due to too many channels.

In order to make the objects, technical solutions, and advantages of the embodiments of the present disclosure more apparent, a clear and complete description of the technical solutions of the embodiments in the present disclosure will be given below in combination with the drawings of the embodiments of the present disclosure. Apparently the embodiments described below are only a part but not all of the embodiments of the present disclosure. Based upon the embodiments here of the present disclosure, all the other embodiments which can occur to those skilled in the art without any inventive effort shall fall into the protection scope of the present disclosure.

Unless otherwise defined, the technical or scientific terms used in the present disclosure shall have a general meaning understood by those skilled in the art to which the present disclosure belongs. The terms “first”, “second” and the like used in the present disclosure do not indicate any order, quantity, or importance, but are merely intended to distinguish different components. Words like “include” or “including” mean that the element or object preceding the word covers the element or object listed after the word and its equivalent, without excluding other elements or objects. Words like “connection” or “connected” are not limited to physical or mechanical connections, but can include electrical connections, whether direct or indirect. Terms like “upper”, “lower”, “left” and “right” are merely intended to represent the relative position relationship, and when the absolute position of the described object changes, the relative positional relationship may also change correspondingly.

In order to keep the following description of the embodiments of the present disclosure clear and concise, a detailed description of the known functions and known parts is omitted in the present disclosure.

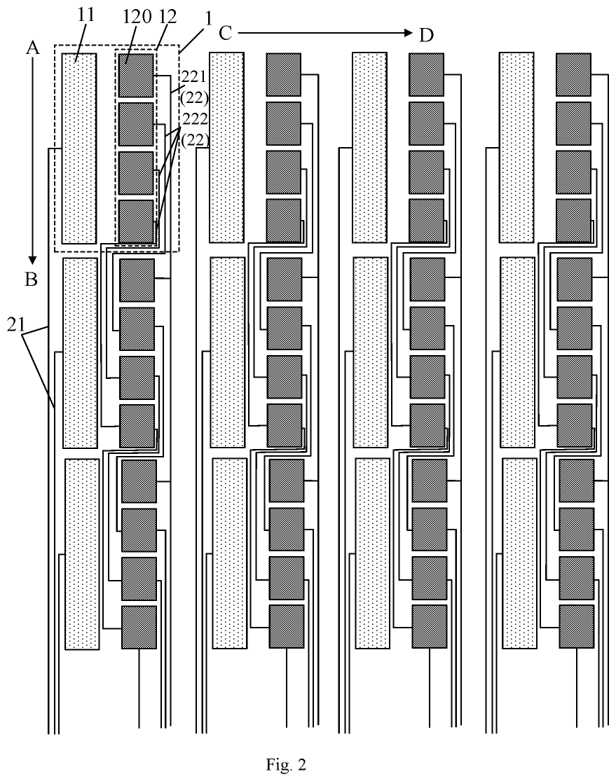

Please refer to FIG. 2 which shows a touch panel provided in an embodiment of the present disclosure. The touch panel includes a plurality of touch units 1 arranged in an array.

Each touch unit 1 includes a first touch electrode 11 and a second touch electrode 12 extending along a first direction AB and arranged along a second direction CD. That is, the first touch electrode 11 and the second touch electrode 12 each is extending along the first direction AB, and the first touch electrode 11 and the second touch electrode 12 are arranged in sequence along the second direction CD. Each second touch electrode 12 includes a number M (for example 4 in FIG. 2) of sub-second electrode blocks 120 arranged in sequence along the first direction AB, and M≥2.

The touch panel further includes first leads 21 electrically connected with the first touch electrodes 11 in a one-to-one correspondence manner. That is, one first lead 21 is correspondingly connected with one first touch electrode 11.

The touch panel further includes second leads 22. Each of the second leads 22 is electrically connected with n^{th} sub-second electrode blocks 120 in respective second touch electrodes 12 in touch units 1 arranged along the first direction AB, and 2≤n≤M. That is, for example, in all sub-second electrode blocks 120 along the same first direction AB, the first sub-second electrode block 120 (that is, the first sub-second electrode block 120 at the topmost of the touch unit 1) belonging to the first touch unit 1 (that is, the first touch unit 1 in the direction from top to bottom in FIG. 2), the first sub-second electrode block 120 in the second touch unit 1 (that is, the second touch unit 1 in the direction from top to bottom in FIG. 2), the first sub-second electrode block 120 in the third touch unit 1 (that is, the third touch unit 1 in the direction from top to bottom in FIG. 2), and the like are all electrically connected through one second lead 22. The second sub-second electrode block 120 in the first touch unit 1, the second sub-second electrode block 120 in the second touch unit 1, the second sub-second electrode block 120 in the third touch unit 1, and the like are all electrically connected through another one second lead 22. In all the sub-second electrode blocks 120 along the same first direction, the third sub-second electrode block 120 belonging to the first touch unit 1, the third sub-second electrode block 120 in the second touch unit 1, the third sub-second electrode block 120 in the third touch unit 1, and the like are all electrically connected through still another second lead 22 . . . , and so on.

The touch panel provided in embodiments of the present disclosure includes: a plurality of touch units 1 arranged in an array. Each touch unit 1 includes a first touch electrode 11 and a second touch electrode 12 extending along a first direction AB and arranged along a second direction CD. Each second touch electrode 12 includes M sub-second electrode blocks 120 arranged in sequence along the first direction, and M≥2. The touch panel further includes first leads 21 electrically connected with the first touch electrodes 11 in a one-to-one correspondence manner, and second leads 22. Each of the second leads 22 is electrically connected with n^{th} sub-second electrode blocks 120 in respective second touch electrodes 12 in touch units 1 arranged along the first direction AB, and 1≤n≤M. That is, during touch, area positioning can be performed on the touch position through the first touch electrodes 11, and channel positioning can be performed through the sub-second electrode blocks 120, Through the combination of the area positioning and channel positioning, the touch position can be positioned accurately, thereby avoiding the problem of multi-finger ghost point. Moreover, compared with the self capacitance touch in the prior art that each touch electrode block needs a touch channel, while in the embodiments of the present disclosure, for all the sub-second touch electrode blocks 120 in the same first direction AB, only M second leads are required, thereby reducing the number of touch channels, and further solving the problem of too many channels of the self capacitance touch which may influence the lower frame size and touch chip size.

During specific implementation, the touch panel in the embodiments of the present disclosure can be a touch panel integrated with the liquid crystal display panel, and can also be a touch panel integrated with the organic light-emitting display panel (including an AMOLED display panel).

During specific implementation, there are various patterns of the touch units, the first touch electrodes and the second touch electrodes, which will be described below through specific examples.

For example, referring to FIG. 2, the touch unit 1 is rectangular, the first touch electrode 11 and the sub-second electrode block 120 are both block-shaped, and the length of the sub-second electrode block 120 in the first direction AB is less than the length of the first touch electrode 11 in the first direction AB. It should be noted that, the first touch electrode 11 and the sub-second electrode block 120 are both block-shaped, which can be understood as follows: the projections of the first touch electrode 11 and the sub-second electrode block 120 are both block-shaped, i.e., a regular shape with no hollow area. For example, the block shape can be specifically a rectangle, a square, a circle or a trapezoid. In some embodiments of the present disclosure, the first touch electrode 11 and the sub-second electrode block 120 are both block-shaped, the pattern is regular and easy to manufacture, and can have a high manufacturing yield.

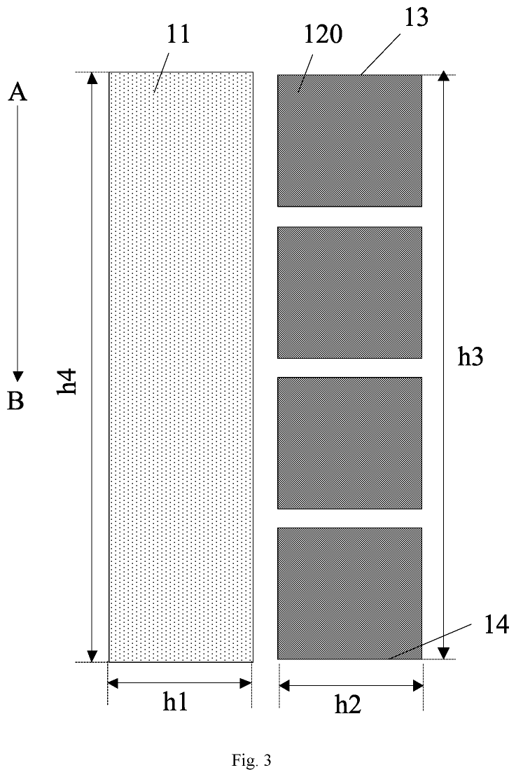

When the first touch electrode 11 is strip-shaped and the sub-second electrode block 120 is block-shaped, specifically, referring to FIG. 3, the width h1 of the first touch electrode 11 along a direction vertical to the first direction AB is equal to the width h2 of the sub-second electrode block 120 along the direction vertical to the first direction AB. In some embodiments of the present disclosure, the width h1 of the first touch electrode 11 is the same as the width h2 of the sub-second electrode block 120, thereby facilitating calculation of the subsequent touch positioning algorithm, and reducing the calculation amount.

When the first touch electrode 11 is strip-shaped, and the sub-second electrode block 120 is block-shaped, specifically, referring to FIG. 3, the shape of each sub-second pixel block 120 in the same touch unit 1 is square. The shape of the first touch electrode 11 is rectangular. Specifically, in the same touch unit 1, a side, far away from the last sub-second electrode block 120, of the first sub-second electrode block 120 is taken as a first side 13, and a side, far away from the first sub-second electrode block 120, of the last sub-second electrode block 120 is taken as the second side 14, then the distance h3 between the first side 13 and the second side 14 can be equal to the extension length h4 of the first touch electrode block 11 in the first direction AB. That is, the first touch electrode 11 and the second touch electrode 12 basically occupy regions with the same area. Specifically, the side length of the square is 4 mm. Specifically, each touch unit 1 can include four sub-second electrode blocks 120.

When the first touch electrode 11 is strip-shaped, and the sub-second electrode block 120 is block-shaped, specifically, referring to FIG. 3, the areas of the respective sub-second electrode blocks 120 in the same touch unit 1 are the same. In some embodiments of the present disclosure, the areas of the respective sub-second electrode blocks 120 in the same touch unit 1 are the same, which can avoid influencing accurate detection of the touch position when the sizes of the sub-second electrode blocks 120 are different.

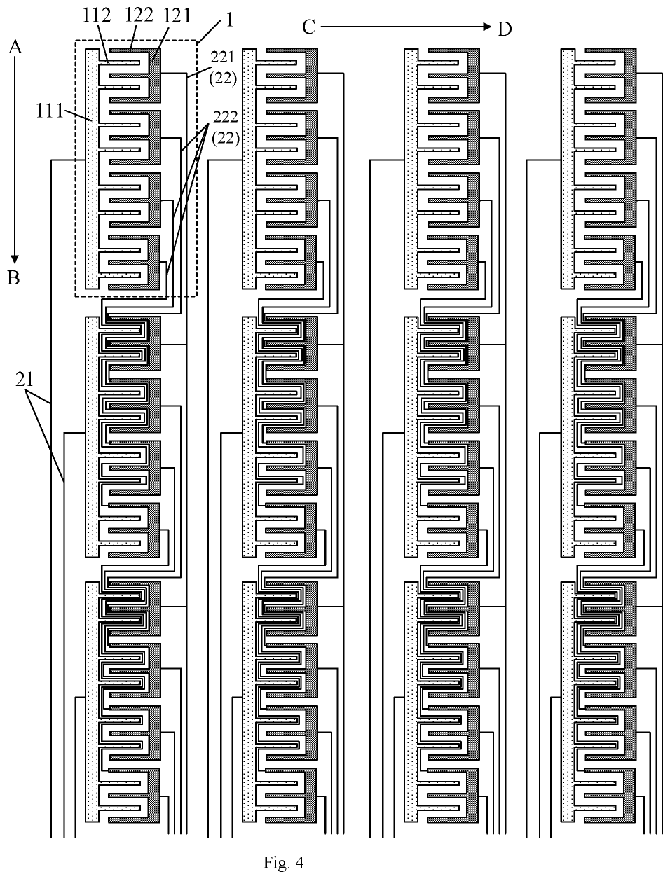

For another example, referring to FIG. 4, the first touch electrode 11 is comb-shaped, and is provided with a first master 111 which extends along the first direction AB, and a plurality of first branches 112 which are connected with the first master 111 and extend towards the side of the second touch electrode 12 along a direction vertical to the first direction AB. The sub-second electrode block 120 is comb-shaped, and is provided with a second master 121 which extends along the first direction AB, and a plurality of second branches 122 which are connected with the second master 121 and extend towards the side of the first touch electrode 11 along a direction vertical to the first direction AB. The first branches 112 and the second branches 122 are distributed alternately. In some embodiments of the present disclosure, the first touch electrode 11 and the sub-second electrode block 120 are both comb-shaped, and the two are in cross-finger distribution and are supplemented mutually, thereby avoiding the problem of touch dead zone during common positioning when the first touch electrode 11 and the sub-second touch electrode block 120 are rectangular, and avoiding the problem of difficulty in detecting touch signals between rectangular gaps.

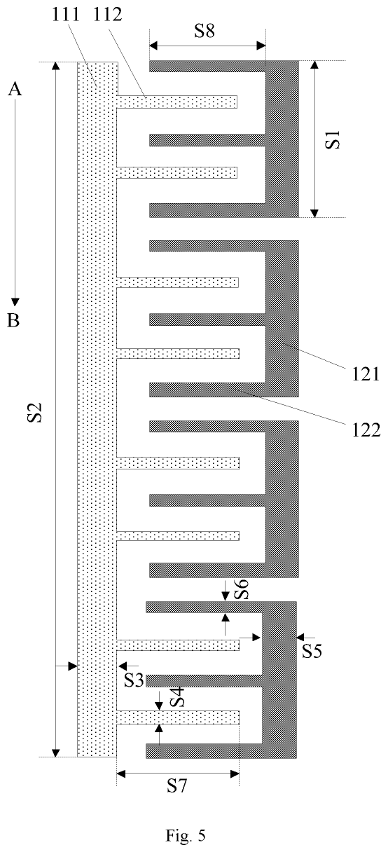

When the first touch electrode 11 and the sub-second electrode block 120 are both comb-shaped, specifically, referring to FIG. 5, the extending length S1 of the second master 122 in the first direction AB is 1/M of the extending length S2 of the first master 111 in the same touch unit 1 in the first direction. Specifically, S1 can be 4 mm, and S2 can be 16 mm.

When the first touch electrode 11 and the sub-second electrode block 120 are both comb-shaped, specifically, referring to FIG. 5, the width S3 of the first master 111 in the direction vertical to the first direction AB is larger than the width S4 of the first branch 112 in the first direction AB. The width S5 of the second master 121 in the direction vertical to the first direction AB is larger than the width S6 of the second branch 122 in the first direction AB. Specifically, S6 can be 0.8 mm.

When the first touch electrode 11 and the sub-second electrode block 120 are both comb-shaped, specifically, the extending length S7 of the first branch 111 is equal to the extending length S8 of the second branch 122. Specifically, S8 can be 4 mm. Specifically, the longer S7 and S8 are, the better. However, too long and thin wiring will increase load.

During specific implementation, as to the first leads 21 in some embodiments of the present disclosure, referring to FIG. 2 or FIG. 4, if the first direction AB is the column direction of the touch units 1, the touch display panel can include multiple groups of first leads 21. Each group of first leads 21 is arranged at the gap position between two adjacent columns of touch units 1, and is electrically connected with each first touch electrode 11 in one adjacent column of touch units 1 in a one-to-one correspondence manner. Specifically, the first lead 21 connected with the first touch electrode 11 is arranged on a side, far away from the second touch electrode 12, in the same touch unit 1. That is, for example, as shown in FIG. 2 and FIG. 4, aiming at the first column of touch units 1 from the left, in one same touch unit, the second touch electrode 12 is on the right side, the first touch electrode 11 is on the left side, and the first lead 21 is on the left side of the touch unit 1, which is a side far away from the second touch electrode 12. In some embodiments of the present disclosure, the first lead 21 connected with the first touch electrode 11 is arranged on a side, far away from the second touch electrode 12, in the same touch unit 1, of the first touch electrode 11. That is, the first lead 21 can be located on a side close to the first touch electrode 11, and the second lead 22 can be located on a side close to the second touch electrode 12, then connection is facilitated. Moreover, when the second lead 22 and the first lead 21 are arranged on the same side, a small routing area is formed, which is not beneficial for wiring of the first lead 21.

During specific implementation, as to the second leads 22 in some embodiments of the present disclosure, that is, referring to FIG. 2 and FIG. 4, the second leads 22 can include: a first type of touch leads 221 each arranged on a side, far away from the first touch electrode 11, of the second touch electrode 12; and a second type of touch leads 222 each of which is bended to form multiple segments for evading from the sub-second electrode blocks 120. In touch units 1 arranged in the same first direction: the first sub-second electrode blocks 120 are connected mutually through one of the first type of touch lead 221, and two n^{th} sub-second electrode blocks 120 in two adjacent touch units 1 are connected mutually through a segment in a second type of touch lead 222, and 1<n≤nM.

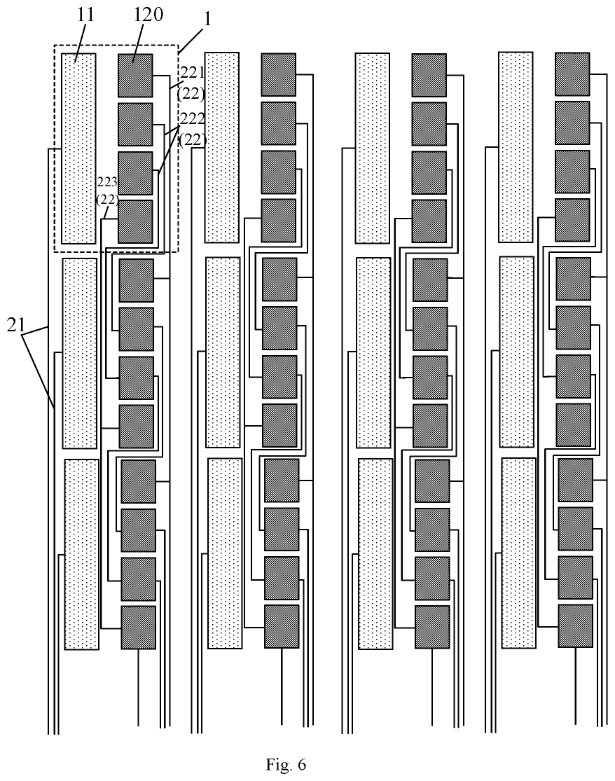

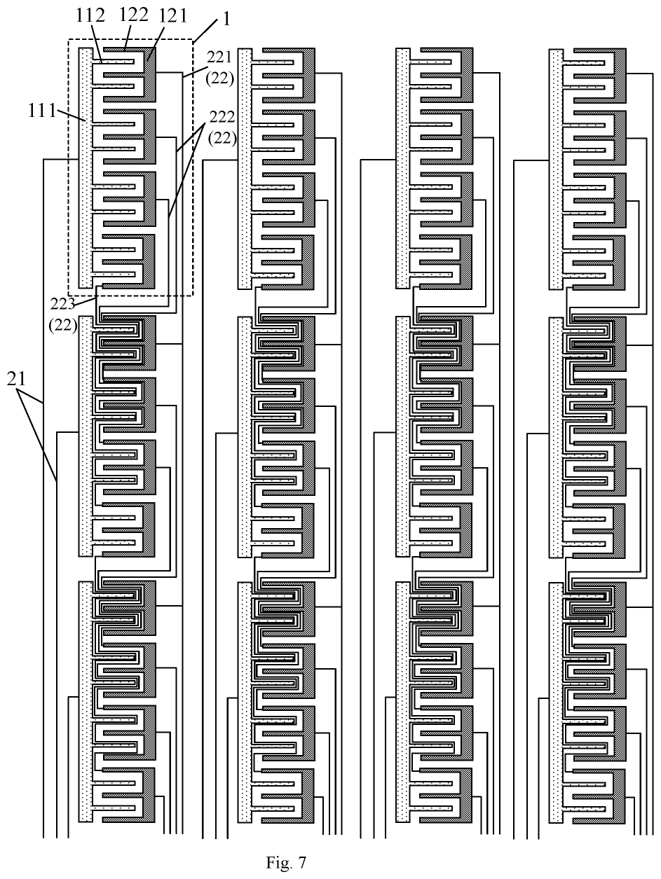

Specifically, referring to FIG. 6 and FIG. 7, the second leads 22 further includes: a third type of touch leads 223 each arranged on a side, facing towards the first touch electrode 11, of the second touch electrode 12. In touch units in the same first direction AB: the last sub-second electrode blocks 120 are mutually connected through one third type of touch lead 223. That is, for the last sub-second electrode block 120 in one touch unit 1, the corresponding second lead 22 can also be arranged between the first touch electrode 11 and the second touch electrode 12 of the one touch unit 1, that is, can be arranged on a side, facing towards the first touch electrode 11, of the second touch electrode 12. In some embodiments of the present disclosure, the second leads 22 further includes a third type of touch leads 223, thereby reducing the condition in which when the second leads 22 are all arranged on the same side of the second touch electrodes 12, the wiring space of the second leads 22 is small and the second leads 22 are complex.

During specific implementation, the first touch electrodes 11 and the second touch electrodes 12 are arranged on the same layer. Specifically, the first leads 21, the second leads 22 are in the same layer as the first touch electrodes 11. In some embodiments of the present disclosure, when the first leads 21, the second leads 22, the first touch electrodes 11 and the second touch electrodes 12 are all in the same layer, the manufacture procedures are effectively reduced, and the yield is improved.

Some embodiments of the present disclosure further provide a touch display device, including the touch panel provided in the embodiments of the present disclosure.

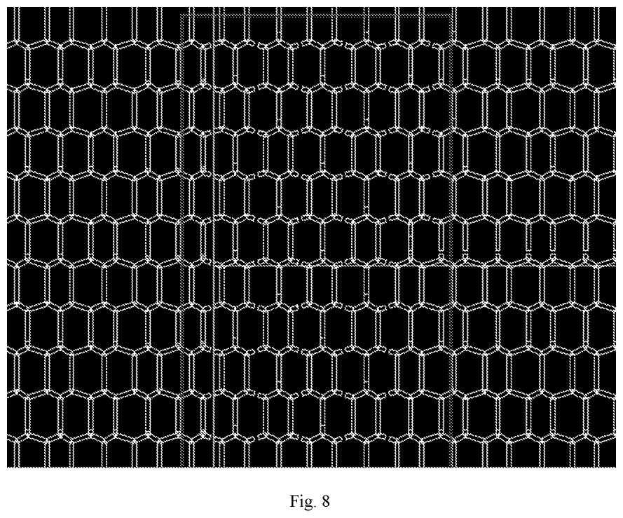

In some possible embodiments, the touch display device further includes a display panel. The display panel includes multiple pixel units. Each pixel unit includes a light transmitting area. The first touch electrode(s), and/or the sub-second electrode block(s), and/or the first lead(s), and/or the second lead(s) are/is provided with a hollow part(s). An orthographic projection(s) of the hollow part(s) on the display panel is/are overlapped with the light transmitting area(s) of the pixel unit(s), as shown in FIG. 8. That is, a small hexagon with a black hole is a hollow part formed by the first touch electrode, and/or the sub-second electrode block, and/or the first lead, and/or the second lead, and the shape of the hollow part is the same as the shape of the light transmitting area of the pixel unit. In some embodiments of the present disclosure, the first touch electrode, and/or the sub-second electrode block, and/or the first lead, and/or the second lead are/is provided with a hollow part, thereby ensuring transmittance and ensuring brightness.

The embodiments of the present disclosure have the following beneficial effects: a touch panel provided in some embodiments of the present disclosure includes a plurality of touch units arranged in an array. Each touch unit includes a first touch electrode and a second touch electrode extending along a first direction and arranged along a second direction. Each second touch electrode includes M sub-second electrode blocks arranged in sequence along the first direction, and The touch panel further includes first leads electrically connected with the first touch electrodes in a one-to-one correspondence manner, and second leads. Each of the second leads is electrically connected with n^{th} sub-second electrode blocks in respective second touch electrodes in touch units arranged along the first direction, and 1≤n≤M. That is, during touch, area positioning can be performed on the touch position through the first touch electrodes, and channel positioning can be performed through the sub-second electrode blocks, through the combination of the area positioning and channel positioning, the touch position can be positioned accurately, thereby avoiding the problem of multi-finger ghost point. Moreover, compared with the self capacitance touch in the prior art that each touch electrode block needs a touch channel, while in the embodiments of the present disclosure, for all the sub-second touch electrode blocks in the same first direction, only M second leads are required, thereby reducing the number of touch channels, and further solving the problem of too many channels of the self capacitance touch which may influence the lower frame size and touch chip size.

Although the preferred embodiments of the present disclosure have been described, however, those skilled in the art can make additional variations and modifications to these embodiments once they learn about the concept of basic creativity. Therefore, the appended claims are interpreted to encompass preferred embodiments and all the variations and modifications falling within the scope of the present disclosure.

Evidently those skilled in the art can make various modifications and variations to the embodiment of the present disclosure without departing from the spirit and scope of the embodiment of the present disclosure. Thus the present disclosure is also intended to encompass these modifications and variations thereto so long as the modifications and variations come into the scope of the claims appended to the present disclosure and their equivalents.

1. A touch panel, comprising:
a plurality of touch units arranged in an array; wherein each of the touch units comprises a first touch electrode and a second touch electrode; the first touch electrode and the second touch electrode each is extending along a first direction and are arranged along a second direction; the second touch electrode comprises a number M of sub-second electrode blocks arranged in sequence along the first direction; and M≥2;
first leads electrically connected with first touch electrodes in the respective touch units in a one-to-one correspondence manner; and
second leads, wherein each of the second leads is electrically connected with n^{th} sub-second electrode blocks in respective second touch electrodes in touch units arranged along the first direction, and 1≤n≤M.

2. The touch panel of claim 1, wherein:
the first touch electrode is comb-shaped, and is provided with a first master which extends along the first direction, and a plurality of first branches which are connected with the first master and extend towards the second touch electrode along a direction vertical to the first direction;
each of the number M of sub-second electrode block is comb-shaped, and is provided with a second master which extends along the first direction, and a plurality of second branches which are connected with the second master and extend towards the first touch electrode along the direction vertical to the first direction; and
the first branches and the second branches are distributed alternately.

3. The touch panel of claim 2, wherein an extending length of the second master in the first direction is 1/M of an extending length of the first master in a same touch unit in the first direction.

4. The touch panel of claim 2, wherein:
a width of the first master in the direction vertical to the first direction is larger than a width of each of the first branches in the first direction; and
a width of the second master in the direction vertical to the first direction is larger than a width of each of the second branches in the first direction.

5. The touch panel of claim 2, wherein an extending length of each of the first branches is equal to an extending length of each of the second branches.

6. The touch panel of claim 1, wherein each of the touch units is rectangular, the first touch electrode is block-shaped, each of the number M of sub-second electrode blocks is block-shaped, and a length of the each sub-second electrode block in the first direction is less than a length of the first touch electrode in the first direction.

7. The touch panel of claim 6, wherein a width of the first touch electrode along a direction vertical to the first direction is equal to a width of the each sub-second electrode block along the direction vertical to the first direction.

8. The touch panel of claim 7, wherein a shape of the each sub-second electrode block in a same touch unit is square.

9. The touch panel of claim 8, wherein areas of the respective sub-second electrode blocks in the same touch unit are the same.

10. The touch panel of claim 2, wherein a first lead connected with the first touch electrode is arranged on a side, far away from the second touch electrode, in a same touch unit.

11. The touch panel of claim 10, wherein the second leads comprise: a first type of touch leads each arranged on a side, far away from the first touch electrode, of the second touch electrode, and a second type of touch leads each of which is bended to form multiple segments for evading from the sub-second electrode block; and
each of the first type of touch leads is electrically connected with first sub-second electrode blocks in respective second touch electrodes in touch units arranged along the first direction, each segment in each of the second type of touch leads is electrically connected with n^{th} sub-second electrode blocks in two adjacent second touch electrodes in touch units arranged along the first direction; and 1<n≤M.

12. The touch panel of claim 11, wherein the second leads further comprises: a third type of touch leads each arranged on a side, facing towards the first touch electrode, of the second touch electrode; and
each of the third type of touch leads is electrically connected with last sub-second electrode blocks in respective second touch electrodes in touch units arranged along the first direction.

13. The touch panel of claim 1, wherein the first touch electrode and the second touch electrode are arranged in a same layer.

14. The touch panel of claim 13, wherein the first leads and the second leads are arranged in the same layer as the first touch electrode.

15. A touch display device comprising a touch panel, wherein the touch panel comprises:
a plurality of touch units arranged in an array; wherein each of the touch units comprises a first touch electrode and a second touch electrode; the first touch electrode and the second touch electrode each is extending along a first direction and are arranged along a second direction; the second touch electrode comprises a number M of sub-second electrode blocks arranged in sequence along the first direction; and M≥2;
first leads electrically connected with first touch electrodes in the respective touch units in a one-to-one correspondence manner; and
second leads, wherein each of the second leads is electrically connected with n^{th} sub-second electrode blocks in respective second touch electrodes in touch units arranged along the first direction, and 1≤n≤M.

16. The touch display device of claim 15, further comprising:
a display panel;
wherein the display panel is provided with a plurality of pixel units, and each of the pixel units comprises a light transmitting area; and
the first touch electrode, and/or the sub-second electrode block, and/or the first lead, and/or the second lead have/has a hollow part, and an orthographic projection of the hollow part on the display panel is overlapped with the light transmitting area of the pixel unit.

17. the touch display device of claim 15, wherein:
the first touch electrode is comb-shaped, and is provided with a first master which extends along the first direction, and a plurality of first branches which are connected with the first master and extend towards the second touch electrode along a direction vertical to the first direction;
each of the number M of sub-second electrode block is comb-shaped, and is provided with a second master which extends along the first direction, and a plurality of second branches which are connected with the second master and extend towards the first touch electrode along the direction vertical to the first direction; and
the first branches and the second branches are distributed alternately.

18. The touch panel of claim 6, wherein a first lead connected with the first touch electrode is arranged on a side, far away from the second touch electrode, in a same touch unit.

19. The touch panel of claim 18, wherein the second leads comprise: a first type of touch leads each arranged on a side, far away from the first touch electrode, of the second touch electrode, and a second type of touch leads each of which is bended to form multiple segments for evading from the sub-second electrode block; and
each of the first type of touch leads is electrically connected with first sub-second electrode blocks in respective second touch electrodes in touch units arranged along the first direction, each segment in each of the second type of touch leads is electrically connected with n^{th} sub-second electrode blocks in two adjacent second touch electrodes in touch units arranged along the first direction; and 1<n≤M.

20. The touch panel of claim 19, wherein the second leads further comprises:
a third type of touch leads each arranged on a side, facing towards the first touch electrode, of the second touch electrode; and
each of the third type of touch leads is electrically connected with last sub-second electrode blocks in respective second touch electrodes in touch units arranged along the first direction.
